(19) United States
(12) Patent Application Publication
(10) Pub. No.: US 2025/0111340 A1
(43) Pub. Date: Apr. 3, 2025

(54) Cloud system defining employment benefits by location-dependent regulations

(71) Applicant: Velocity Global, LLC, Denver, CO (US)

(72) Inventors: Siddharth Ram, Palo Alto, CA (US); Kumar Ramanathan, Sunnyvale, CA (US); Michael McGuire, Denver, CO (US)

(21) Appl. No.: 18/476,958

(22) Filed: Sep. 28, 2023

(51) Int. Cl. G06Q 10/105

(52) U.S. Cl. CPC G06Q 10/105

(57) ABSTRACT

Systems and methods for providing various Human Resources (HR) services to a company are provided. A method, according to one implementation, includes the step of monitoring employment policies and updates thereto, the employment policies representing employment laws, rules, and/or regulations applicable to each of a plurality of jurisdictions (e.g., countries, states, provinces, etc.). The method also includes the step of displaying multiple options and fields on one or more screens of a User Interface (UI) of a remote user device allowing a user to enter information defining a job to be executed by a job candidate or new employee. Also, the method includes the step of detecting whether the information entered by the user complies with the employment policies.

### TECHNICAL FIELD

The present disclosure generally relates to computer-implemented systems and methods. More particularly, the present disclosure relates to a cloud-based system for automating Human Resources (HR) practices based at least on the physical locations of remote or on-site employees.

### BACKGROUND

More than ever, people throughout the world are interconnected via the Internet. Even in business, collaboration tools are available to allow workers to work together on projects from many different perspectives as well as from many different locations. Remote work or Work from Home (WFH) systems have been established to enable workers to work virtually anywhere in the world. This of course has changed the workplace environment from a centralized brick and mortar paradigm to a “work anywhere” paradigm meaning a company can have employees anywhere, including across the globe. Having employees in different countries is a complex undertaking, requiring companies to build large Human Resource (HR) and compliance departments.

### BRIEF SUMMARY

The present disclosure is directed to systems and methods for managing employment functionality for a company, business, or the like. According to one implementation, a method includes the step of monitoring employment policies and updates thereto, wherein the employment policies represent employment laws, rules, and/or regulations applicable to each of a plurality of jurisdictions, wherein the employment policies are captured in a data format and the updates are maintained via a version control feature. The method further includes the step of displaying multiple options and fields on one or more screens of a User Interface (UI) of a remote user device allowing a user to enter information defining a job to be executed by a job candidate or new employee. Also, the method includes the step of detecting whether the information entered by the user complies with the employment policies.

The method may also be executed according to various implementations. For example, the remote user device may be associated with a company for which the job is intended to be filled. The user may be administrative, executive, or Human Resources (HR) personnel representing the company. The method may be executed by a cloud-based server configured to provide automated HR services for the one or more companies or employers. The method may further include the step of displaying a quote on the UI, where the quote may be a cost for the cloud-based server to serve the company with respect to the HR services.

The step of displaying the multiple options and fields may include the steps of a) displaying compensation options and fields and b) displaying benefits options and fields. The step of detecting whether the information entered by the user complies with the employment policies may include a first step of detecting whether compensation information entered by the user complies with the employment policies with respect to a selected jurisdiction, where the compensation information is related to a) an annual salary, b) an hourly wage, c) equity, d) variable compensation, e) bonuses, f) allowances, g) retirement matching, and/or other elements related to compensation. The step of detecting whether the information entered by the user complies with the employment policies may further include a second step of detecting whether benefits information entered by the user complies with the employment policies with respect to the selected jurisdiction, the benefits information related to a) Paid Time Off (PTO), b) medical/health insurance, c) life insurance, and/or other benefits.

The plurality of jurisdictions, for example, may include a plurality of countries throughout the world. Each of one or more of the plurality of countries may include one or more states, provinces, territories, cantons, divisions, regions, landers, governorates, parishes, or prefectures each having their own set of employment policies.

The method may further include automatically managing one or more of a) a first set of tasks related to recruiting and onboarding new employees, b) a second set of tasks related to payroll and timekeeping, c) a third set of tasks related to employee relocation, and d) a fourth set of tasks related to termination or retirement of employees. The method may also include the step of updating the first, second, third, and fourth sets of tasks based on updates to the employment policies.

In some embodiments, the method may also include the step of displaying hiring guidelines on the UI, where the hiring guidelines may be related to the employment policies of one or more of the plurality of jurisdictions. The method may also consider factors regarding locations of one or more job candidates with respect to one or more of a) hiring locally, b) hiring internationally, c) remote work, d) establishing a subsidiary in another jurisdiction, e) passport policies, f) immigration policies, and g) work visa policies.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a network diagram illustrating a cloud-based employment system for enabling the automatic execution of various Human Resources (HR) functionalities, according to one embodiment.

FIG. 2 is a block diagram illustrating the server shown in FIG. 1 for performing HR functionality, according to one embodiment.

FIG. 3 is a block diagram illustrating the employment management program shown in FIG. 2, according to one embodiment.

FIG. 4 is a diagram illustrating aspects of executing software components of the employment management program of FIG. 3, according to one embodiment.

FIG. 5 is a diagram illustrating offline processes, online processes, and version control processes associated with the employment management program of FIG. 3, according to one embodiment.

FIGS. 6-32 are screenshots of user interfaces associated with execution of the employment management program of FIG. 3, according to various embodiments.

FIG. 33 is a flow diagram illustrating a method for managing employment functionality for a business, according to one embodiment.

### DETAILED DESCRIPTION

As mentioned above, remote working scenarios (e.g., Work from Home (WFH), coworking, etc.) allow workers to work essentially anywhere in the world where Internet access is available. The present disclosure relates to systems and methods for managing the Human Resources (HR) aspects of such businesses in a way that requires less time for HR personnel and is able to automatically handle certain HR functions efficiently and effectively. In particular, the systems and methods of the present disclosure are configured to keep track of the various employment laws, rules, regulations, etc. that are applicable to different countries. Even within certain countries, a country may be divided into specific jurisdictions whereby each state, province, territory, etc. (any division or jurisdiction) within that country may also have its own set of employment rules and regulations. As an example, some jurisdictions may include employment laws in which an employer is required to provide each employee with a minimum amount of Paid Time Off (PTO), such as 20 days per year. PTO, for example, may include annual leave, sick leave, personal time off, etc. Thus, the systems and methods of the present disclosure are configured to ensure that employers (e.g., businesses, companies, organizations, enterprises, etc.) comply with the applicable laws wherever their employees are working.

Since some companies may be set up where their employees can be physically located all over the world, there may be cost advantages in some cases to having certain positions (e.g., engineers) held by people in different areas (e.g., India, Slovenia, etc.) instead of an expensive area like Silicon Valley. To support a global workforce, some big companies may have vast legal departments and establish subsidiaries in each country. For example, Big Company X may have “Big Company X India” and “Big Company X Slovenia” as subsidiaries. Also, Big Company X may be required to maintain HR, legal, compliance, etc. in each of the countries in which it operates or has employees.

Of course, maintaining a presence in different countries can be quite expensive and may require a large amount of effort and resources. Even for Big Company X, they may need to decide whether or not it would be worth it to expend their resources and efforts to “set up shop” in a given country. Therefore, one feature of the systems and methods of the present disclosure is that automated calculations can be performed to help executives and administrators to determine if it would make economic sense to enter certain new markets to leverage the local talent or if it would be better to draw from candidates within one area (e.g., Silicon Valley) and keep them centralized in that area. It is a further feature of the systems and methods to reduce and automate the effort and resources to support different countries. Furthermore, these decisions may be even more difficult for Small Company Y.

Also, as mentioned above, talent is no longer considered to be centralized in one area (e.g., within the Silicon Valley area). According to some examples, companies have found that highly qualified engineers may be dispersed throughout the world. For example, some companies have found that there may be qualified talent in software development in Eastern Europe, India, Israel, etc.

Suppose, for instance, that a small startup company has received business funding and is located in Silicon Valley, but they want to hire some remote software developers. Suppose in this example that they need a group of ten engineers and wish to pick candidates from Slovenia. In some cases, the startup may have already identified this group of engineers, but in other cases, the company may need some help to find them. If it is determined, for example, that it is too expensive or too difficult to create a Slovenian remote office, they may decide to bring this group to Silicon Valley to work with the existing employees.

Therefore, especially for smaller companies, there is a need for a cloud-based service platform that is able to perform candidate recruitment, onboarding, etc. and to perform other HR-related tasks, such as payroll and timekeeping. In this sense, a centralized server, according to the various aspects of the present disclosure, may be configured to handle much of the HR tasks automatically, thereby providing more efficient usage of resources.

Conventional systems typically require HR personnel to manually onboard new employees and perform other tasks such as payroll, timekeeping, benefits processing, etc. One issue with the conventional systems, however, is that it requires the HR staff to keep track of changes in the various employment laws throughout the world. This, of course, can be an extremely challenging task and may occasionally result in failing to adhere to certain employment laws. Typically, a company would have to engage expert resources to manage the compliance to the corresponding employment laws and regulations. Therefore, one goal of the present disclosure is to provide systems and methods that can automatically track, keep updated records of, and monitor changes to employment laws, rules, regulations, etc. throughout the world to easily allow an administrator or executive to quickly determine business costs for hiring locally or internationally. Also, the embodiments described herein allow administrators and executives to monitor where employees may be recruited from to ensure compliance with various employment laws (e.g., Paid Time Off (PTO), benefits, holidays, compliance, insurance, etc.).

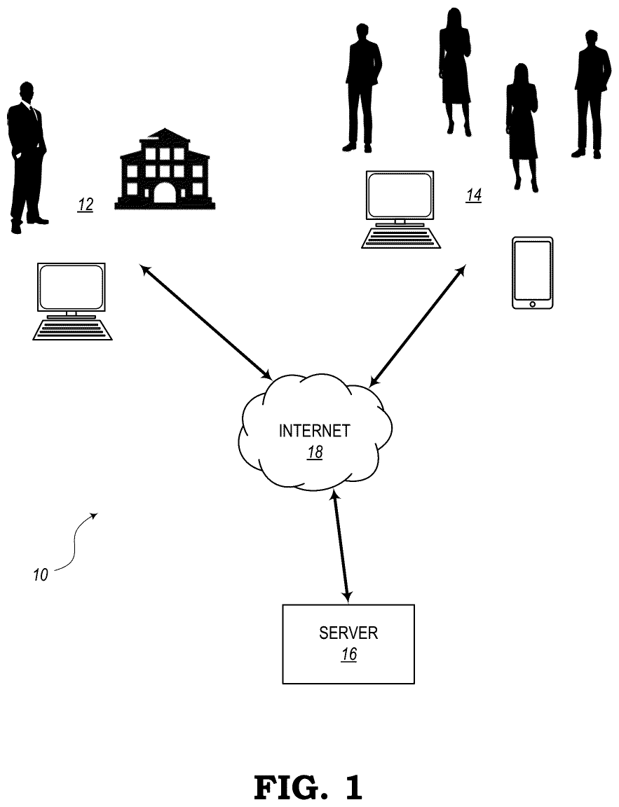

FIG. 1 is a network diagram illustrating an embodiment of a cloud-based employment system 10 for enabling the automatic execution of various HR functions with respect to one or more companies, businesses, organizations, enterprises, etc. As illustrated, the cloud-based employment system 10 generally includes a number of employers 12, a plurality of employees 14 (note, the employees 14 can be contractors, part time workers, or anyone who is paid by the employers 12 for their services), and a server 16 in communication with each other via the Internet 18, a Wide Area Network (WAN), or the like. Each employer 12 may be a company, business, or other type of enterprise, where one or more administrators (admin), managers, executives, hiring staff, etc. may perform various HR tasks for onboarding and maintaining employees 14. Although, for the sake of simplicity, a single employer 12 is shown in FIG. 1 and is described in various embodiments throughout the present disclosure, it should be noted that the server 16 may be configured to service multiple employers 12, each having its own group of employees 14.

It should also be noted that some employees 14 may be physically located at one or more centralized offices (in any country) associated with the employer 12, while some employees 14 may be located physically remote from these centralized offices (e.g., working from home, working from a public library, working from a coffee shop or co-working center, etc.). Each one of the employers 12, employees 14, and the server 16 may be associated with any suitable type of computing device (e.g., personal computer, laptop computer, tablet, mobile phone, etc.) for enabling communication through the cloud-based employment system 10 via the Internet 18. According to various implementations, many of the employment or HR duties may be automated, where little or no human interaction is needed for some of these duties.

The server 16 is configured as part of a cloud platform, system, service, etc., and enables the employers 12 and employees 14 to perform certain employment-related tasks (e.g., HR-related tasks, from onboarding, to payment and compliance, and offboarding). The cloud-based employment system 10 may include various applications (apps) on the computing device that can enable the employees 14 to enter their personal information (e.g., residence address, bank accounts, etc.). Also, the employers 12 may wish to create a job description to define aspects of one or more jobs that may be needed, some of which may include requests for employees 14 in different countries. By entering employee candidate information, the employers 12 can either identify known people who can handle certain jobs, for which there is an opening, or can provide a request that the server 16 can be used to find one or more candidates that meet the entered criteria. For example, the employer 12 might enter information pertaining to pay, title, duties, etc. The cloud-based employment system 10 can automate the entire HR process from onboarding a new employee 14, to paying the employee 14, to managing the relationship between the employee 14 and the employer 12 (e.g., PTO, hours worked, benefits, etc.), to offboarding.

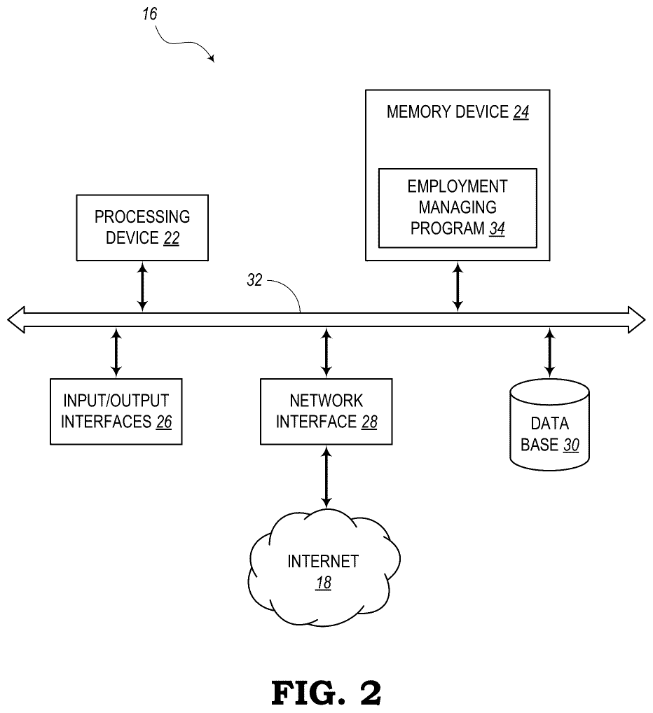

FIG. 2 is a block diagram illustrating an embodiment of the server 16 shown in FIG. 1 for performing HR functionality. In the illustrated embodiment, the server 16 may be a digital computing device that generally includes a processing device 22, a memory device 24, Input/Output (I/O) interfaces 26, a network interface 28, and a database 30. It should be appreciated that FIG. 2 depicts the server 16 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Furthermore, the server 16 also includes an employment managing program 34, which may be implemented in any suitable combination of hardware, software, firmware, etc. For example, in some embodiments, the employment managing program 34, as shown, may be incorporated in non-transitory computer-readable media (e.g., the memory device 24) and may include logical code or instructions for enabling the processing device 22 to perform various functions associated with the management of employment-type aspects, such as HR-type processes.

The cloud-based employment system 10 can utilize one or more servers 16 and can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based employment system 10 is illustrated herein as an example embodiment of a cloud-based system, and other implementations are also contemplated to implement the various techniques described herein.

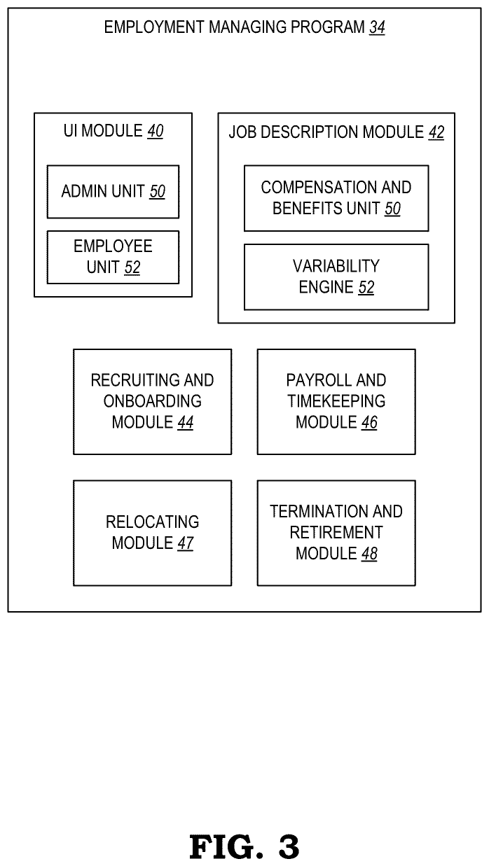

FIG. 3 is a block diagram illustrating an embodiment of the employment managing program 34 shown in FIG. 2. As shown in this embodiment, the employment managing program 34 includes a User Interface (UI) module 40, a job description module 42, a recruiting and onboarding module 44, a payroll and timekeeping module 46, a relocating module 47, and a termination and retirement module 48. The UI module 40 further includes an admin unit 50 for allowing an administrator to interface with the employment managing program 34 and an employee unit 52 for allowing an employee (or a job candidate) to interface with the employment managing program 34. Furthermore, the job description module 42 includes a compensation and benefits unit 54 and a variability engine 56. The various modules can be implemented as methods having steps, via the server 16 or the cloud-based employment system 10 configured to execute the steps, and as non-transitory computer-readable medium storing instructions for programming one or more processors to implement the steps.

The compensation and benefits unit 54 of the job description module 42 allows an administrator to enter compensation information (e.g., salary, full-time pay, part-time pay, hourly pay, profit sharing, retirement payments and matching, taxes, pay schedules, bonuses, potential for raises, etc.). This compensation information can be entered for each job that might be defined according to title, position, duties, experience, etc. The admin can also use the compensation and benefits unit 54 to enter or select benefits for each type of job. The benefits may include the amount of Paid Time Off (PTO) hours or days that may be offered to the employees, such as annual leave, sick leave, personal time off, etc. Benefits may also include holidays or other special days off. Benefits may also include various insurance offerings, such as health/medical insurance, disability insurance, workers compensation, life insurance, dental/vision insurance, etc. Benefits may also include the possibility of union representation and/or membership in certain societies, organizations, charities, etc.

The variability engine 56 may be implemented in a way to encode local employment laws so that the workflow may be substantially the same for all available countries (e.g., the 185 or so countries throughout the world where remote employees may reside and where Internet access may be available). The variability engine 56 may be configured in communication with governmental or employment websites or databases throughout the world for downloading the laws, rules, regulations, etc. regarding various employment policies. The variability engine 56 can also track changes that are made to each website or database to keep an updated record (e.g., in database 30) of each country's policies and/or the policies of various jurisdictions (e.g., states, provinces, territories, etc.) within each country. Thus, the variability engine 56 can be encoded with the applicable laws and rules throughout the world and/or have direct access to this information via a suitable database (e.g., database 30).

That is, the variability engine 56 is configured to work hand-in-hand with the compensation and benefits unit 54 to ensure that the compensation information and benefits information entered for each job associated with each jurisdiction is compliant with the relevant laws and regulations within those jurisdictions. The variability engine 56 may be configured to block the user (e.g., admin) from entering a benefits package that does not completely comply with the laws of a certain country in which a candidate (or employee) will eventually be working. For example, if the user (admin) attempts to enter PTO information giving an engineering candidate 15 days off per year, while the laws in the relevant country require that employers give at least 20 days, then either the variability engine 56 will not allow this amount to be entered and/or may provide an alert telling the user that the amount does not comply with the relevant laws.

The laws, rules, regulations, etc. (“rules”) may be encoded in the variability engine 56 using any suitable data format or language (e.g., YAML, JavaScript Object Notation (JSON), S3 buckets, etc.). YAML is a human-readable data-serialization language. It is commonly used for configuration files and in applications where data is being stored or transmitted. JSON is an open standard file format and data interchange format that uses human-readable text to store and transmit data objects consisting of attribute-value pairs and arrays. It is a common data format with diverse uses in electronic data interchange, including that of web applications with servers. S3 Buckets are public cloud storage containers for objects stored in simple storage service (S3). S3 buckets can be likened to file folders and object storage. That is, the laws, rules, regulations, etc. for each country, state, province, region, city, or any other governmental entity, as well as policies, rules, etc. for a given employer 12 can be encoded in a data format or language.

In some embodiments, the variability engine 56 may use a suitable type of version control feature (e.g., Git, GitHub, etc.) for detecting changes in the laws, rules, code, etc. Although Git is normally applicable to software development version control monitoring, the variability engine 56 can use version control (or Git) in the same or similar manner to control (or monitor) the versions of the local employment laws. Git is a distributed version control system that tracks changes in any set of computer files, usually used for coordinating work among programmers who are collaboratively developing source code during software development. Its goals include speed, data integrity, and support for distributed, non-linear workflows. The present disclosure contemplates the unique combination of using a suitable data format for encoding the rules and the version control feature for managing changes thereto.

Rules may include capturing some information from a person, verifying that information, offering that person some benefits, collecting tax for and/or from that person, paying insurance, offering time off, offering holidays, etc. That is, the rules can be a) data captured from the company, employee, or both, b) data validation of any captured data (e.g., from any database, datastore, etc.), and/or c) actions-pay the employee every two weeks, deduct taxes, pay insurance, give time off, etc. Rules can also be in the following data format: a) Defined structure, b) Interpreted at runtime, and c) Version control (Git). One goal may be for full automation from initial contact to payday through termination. Thus, the systems and methods of the present disclosure may include a cloud platform where there is no need to have someone do much of the typical HR work, such as fully automating the onboarding and payroll tasks.

The admin unit 50 of the UI module 40 may include a collection of UIs that allow an administrator, executive, hiring staff, or other person to enter information (e.g., address, phone numbers, etc.) about the business. The job description module 42 is configured to allow the admin to enter information about one or more jobs that need to be filled or have been filled. For example, the compensation and benefits unit 54 may be configured to allow the entry of compensation for each of the jobs and benefits (e.g., PTO, holidays, insurance, allowances, etc.) for each job. The variability engine 56 may also be configured to compare the enter compensation and benefits information to determine if the selected amounts comply with local laws. Also, the information retrieved by the variability engine 56 may also be used to provide options for the admin, such as an option to select a minimum amount of PTO based on the law, the minimum amount plus 5 days, the minimum amount plus ten days, etc.

The employee unit 52 of the UI module 40 may include a collection of UIs that allow a job candidate to enter information about himself or herself. Also, if the candidate is hired, this information can be saved and used for the same person who will then be identified as an employee. The candidate, new hire, or employee can use the employee unit 52 to enter and/or change personal information, such as residence address, bank account information (e.g., for automatic deposits), etc. as needed. Also, the employee can select various choices regarding insurance using the UI module 40.

In some embodiments, the employment managing program 34 also includes functionality to help with recruiting and onboarding. For example, the recruiting and onboarding module 44 may be configured to determine a specific business employment need and create a job description (e.g., title, position, salary, benefits, etc.) automatically based on the need. The recruiting and onboarding module 44 may also be configured to assist with seeking out new employees and/or advertising for job openings. Also, the recruiting and onboarding module 44 can automatically assist with scheduling interviews with candidates, narrowing down a list of candidates, and determining the most qualified candidates based on certain criteria. The recruiting and onboarding module 44 can also provide an offer letter to one or more selected candidates, receive replies regarding offer letters, and determine start times when the new employees may start. When a candidate is hired, the recruiting and onboarding module 44 can instruct new employees and offer assistance with onboarding processes to ensure the relevant benefits are properly enacted, the employee information is correct, manager information is entered, etc.

Also, the payroll and timekeeping module 46 may be configured to pay employees (e.g., using autopay or other methods) according to the compensation entered with respect to the compensation and benefits unit 54. Also, payments can be made based on a predetermined schedule and may include taking out taxes, Social Security, Medicare, etc. for each employee. Payroll tasks may also include invoicing functions. Also, timekeeping functions may include detecting hours worked (e.g., for an hourly employee), checking attendance, determining PTO used, determining bonuses and overtime hours, recording billable hours, etc.

The relocating module 47 is configured to monitor the physical location of each employee, particularly where the employee goes to perform their work duties. In some cases, an employee may live in one state (or country) while working (e.g., in an office, in a coworking space, etc.) in another state. If an employee relocates to another country, state, province, territory, etc., the relocating module 47 can assist (along with the variability engine 56) to ensure that the employee's compensation and benefits remain compliant with the local laws and make changes to the employee's contract if changes are needed. The relocating module 47 may also assist with immigration laws, international labor laws, passport processing, via processing, work visas, business visas, employment visas, etc. to ensure compliance in all aspects of employment and HR policies.

The termination and retirement module 48 may be configured for assistance with employees who are terminated or who are retiring from the company. This process may include determining severance pay, unemployment benefits, pensions, etc. and/or may include conducting tasks related to retirement accounts. The termination and retirement module 48 may also be configured to automatically change payroll information as needed and update employee information (e.g., new residence information).

The employment managing program 34 can be implemented on the server 16 shown in FIG. 1. In particular, the employment managing program 34 can include a number of layers for enabling the management of various employment functions, such as HR functions. For example, as shown, the employment managing program 34 can include an infrastructure layer, a shared capabilities layer, an analytics layer, a business capabilities layer, an Application Programming Interface (API) layer, and a presentation layer. As described below, the employment managing program 34 includes a combination of API and User Interface (UI) features that may be configured to service both employer representatives (e.g., administration personnel (admin), executives, hiring personnel, etc.) as well as employees.

The employment managing program 34 can include a GUI dashboard. The layers in the employment managing program 34 toward the top may be configured to change faster than layers toward the bottom. A unified, governed API may be created through the API layer. The layers below this can expose their APIs through the API layer. The employment managing program 34 may be developed with an API-first scenario. Every domain may own an unambiguous set of API endpoints that it may implement. Every domain may also publish events about their domain and other domains and may consume events relevant to them.

The presentation layer near the top is what is generally considered as a software product that may be installed on the server 16 and that the employers 12 (and employees 14) may use. Some of these (e.g., employment PTO time, attendance, immigration, expenses, benefits, etc.) may belong to workforce management. The light green color is part of financial management and data. There are also sales and support. A couple items are shown with dotted lines because the target state may allow UIs to be modeled accordingly.

includes visual elements (UIs) and how the employers 12 and employees 14 may interact with it (APIs). Thus, the platform may be the API layer and everything underneath it.

Information that is captured for each candidate may then be used (or reused) for another candidate or some draft form may be used as a template. The employment managing program 34 may be configured with mock offer draft that can be used for recruiting and onboarding. The offer draft may be relatively straightforward since the back end may have offers as a first class entity and an API for it.

Layers towards the top tend to change faster than the layers towards the bottom. Like at the very bottom infrastructure layer (paved road), one would expect the paved road to be established and as long as a user is on the paved road, it doesn't have to change much. Every layer that is below the API layer may expose their interfaces through the API. Each of these boxes can be thought of as having two doors-a front door and a back door, where the front door is the API.

The employment managing program 34 can allow a user to interact with the particular domain. Each domain will also publish events of things that it deems important and everybody else can consume it. For example, when a new employee is added and the onboarding is complete, the next step may be to set up their first payroll. Employment (HR) may publish a message that a new employee has been onboarded. However, employment does not have to know that the admin needs to set a payroll, but payroll would know that every new employee needs to get a new payroll.

Rather than keep polling API endpoints to see if something new has changed, the information may be entirely encapsulated within that domain. One of the advantages of this is that if something changes in employment, admin will not have to go change several other things or even know how payroll works. As long as employment says the API is the same and the published are the same, the admin can change everything underneath that, and it doesn't matter. Also, the employment managing program 34 can serve this capability through CXP or through one of a new API (or new services) in the back end, as long as the API is the same and the events are the same.

This gives autonomy, speed, and velocity to the team that owns the domain and also lines up with code owners. API First and the front end in the case of SSA may be independent of the back end because the contract may already be agreed upon. Another advantage is that API now becomes a first class citizen in the overall equation and exists as part of an HR ecosystem. This can be integrated with the rest of the ecosystem, and it may expose exactly how the domain is modeled in the real world.

Every domain may have an unambiguous API endpoint for simple implementation and every domain can then publish. LNR architectures may be work in progress. Each one of the boxes can have additional details underneath it and the user can drill it down up to the point where they have a catalog of services and endpoints that every domain implements. It can also include a catalog of all of the events that are published. And so that's why this is called a Level 0 architecture. This represents the highest level of technology available.

The solutions to various challenges with implementing the API and UI modules are described here. A first challenge was documenting API, which can be solved by using Stoplight to document the APIs and allows the use of documents the way that they may be intended to look like, how requests should look, and may also include UIs for those requests for the front end to use. The UIs may be built out from the screens shown herein. The APIs are developed with capabilities alongside the UIs, allowing them to be used and delivered on a rapid timeline.

A second issue is related to persistence of data. The systems and methods of the present disclosure are able to combine UI and API technologies, which can respect the confidentiality of some of the data that is stored. Also, as described below, the systems and methods are able to balance this with an easy to use user experience as well. For example, the employment managing program 34 may be configured to resume even if a browser has been closed or if a computer has shut off without issue. This may be applicable to a combination of browser memory and also API storage. This may be a front end and back end pairing that really can make a powerful teaming.

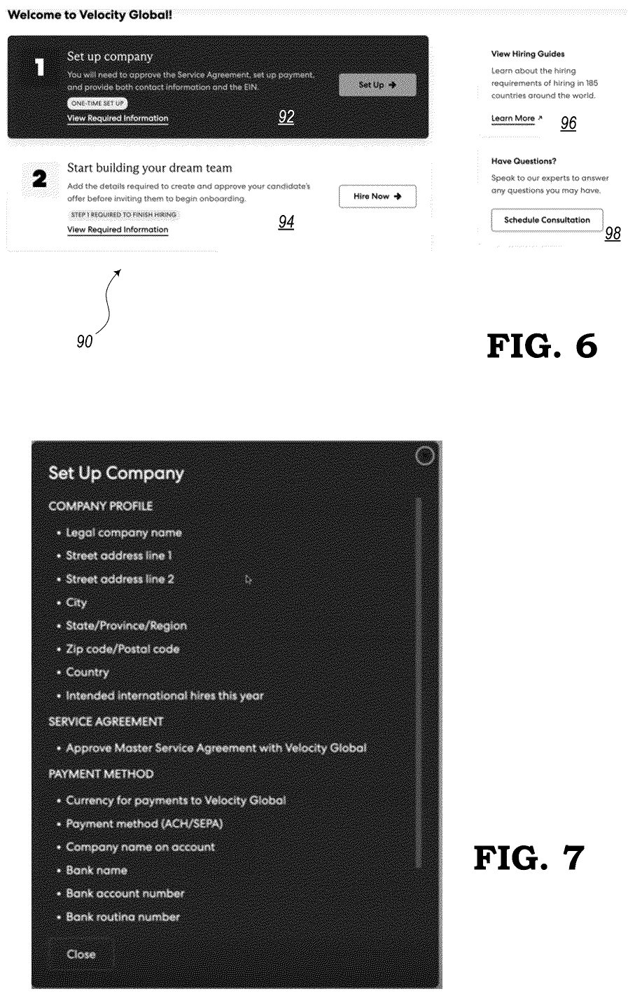

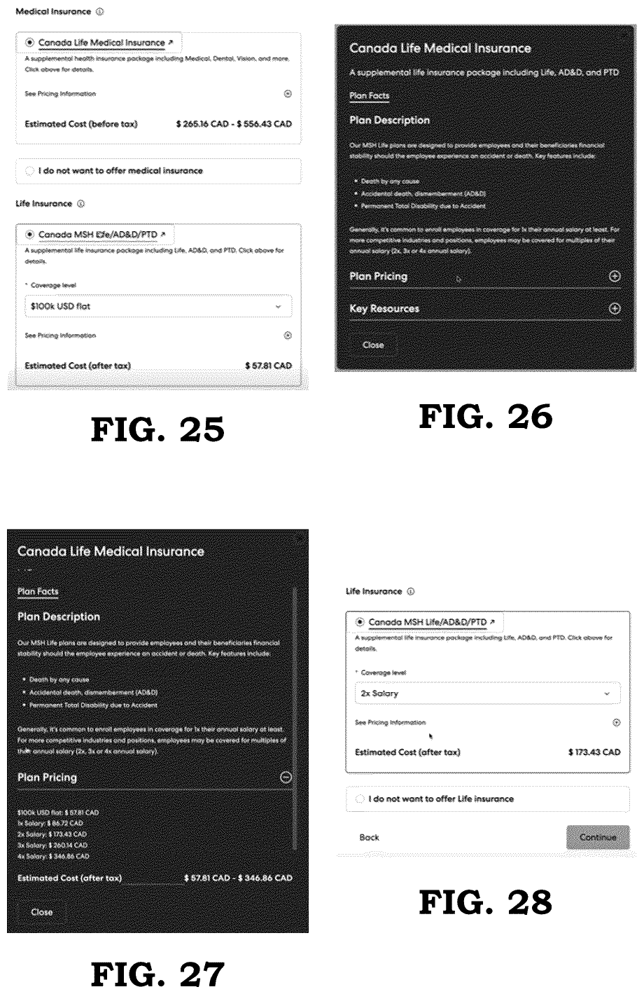

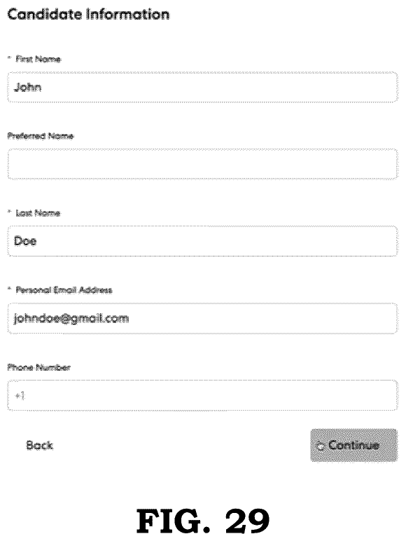

A third challenge was the issue of rebranding. The design of the employment managing program 34 may include the screenshots shown with respect to FIGS. 6-32 and/or may be changed as needed with various styles. Regarding universal components, an authorization package can be used to help configure Monorepo and the pipeline itself.

And lastly, reusing API calls may be a challenge that is solved by the embodiments described herein. This solution may include using a library called React Query, which may be part of the front end RFC. Through the first three challenges, it may be beneficial to parallelize the work. This allows the design of the front end and back end to work in parallel. In some embodiment, it may be possible to swap mocked data from Stoplight with real APIs once the back end has been developed. The ability to work in parallel and have a quick turnaround time can be beneficial to come back together and combine everything.

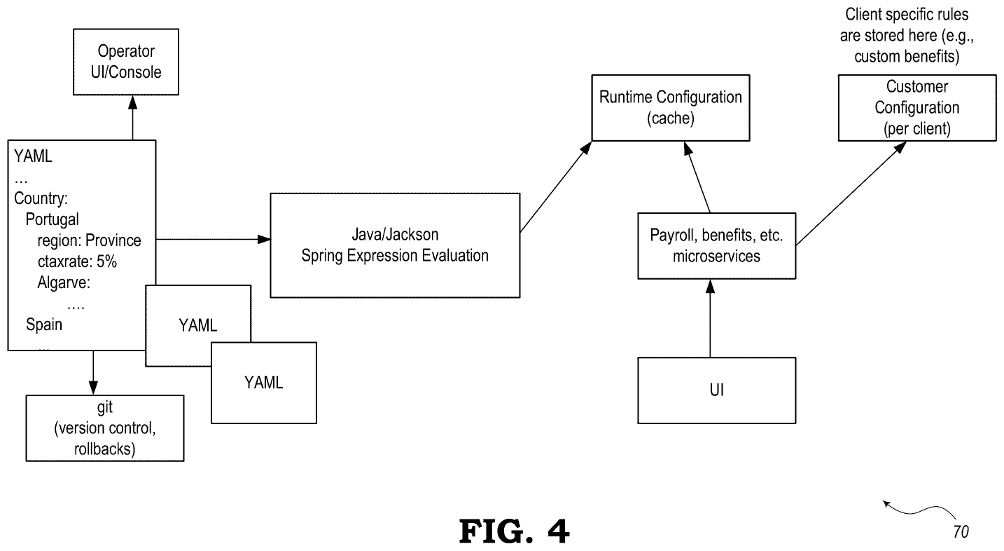

FIG. 4 is a diagram illustrating an embodiment of a software system 70 having aspects related to executing various software components of the employment management program 34. In some embodiments, a business may support myriad payroll, tax, and benefits rules in all the applicable countries (e.g., 185 countries where many companies may allow remote workers) in addition to the US. In addition, admin of some companies may choose to define their own rules for benefits, such as, for example, to provide a more generous number of days off than the minimum requirement.

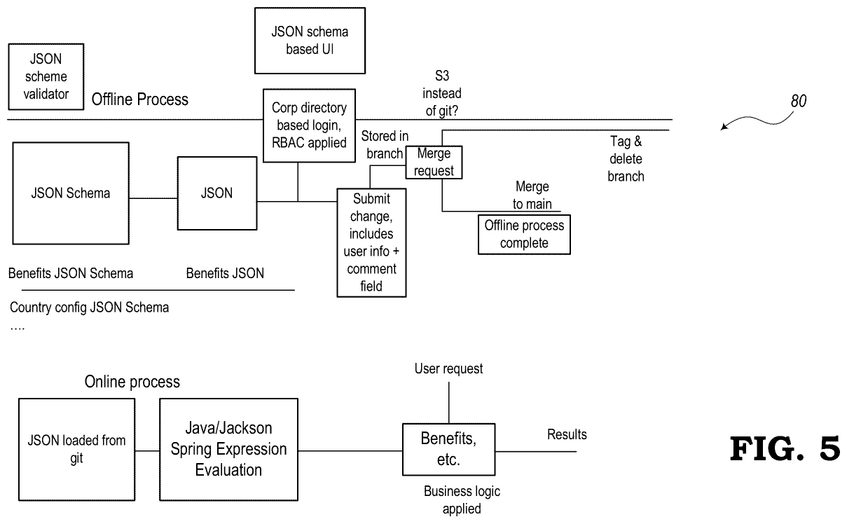

FIG. 5 is a diagram illustrating an embodiment of a system 80 having offline processes, online processes, and version control processes associated with the employment management program 34. According to some embodiments, rules may be captured in a YAML file or S3 bucket. Operators (e.g., admin, HR personnel, etc.) can change the rules using a UI built on top of the YAML file. The YAML file may be stored in Git, which may allow version control of the data and rollbacks. All changes, for example, may be in a Git audit log. A JSON Schema may be used to ensure the data is correct, and the loaded data may be validated against the schema using libraries like djv. The YAML file may be converted to runtime configuration, which may be served up by a configuration microservice. Expressions (e.g., “Algarve has country tax rate+1%”) are evaluated using spring expression evaluation. Jackson, Java parser, NodeJS parser, etc. may be used to create a runtime config, which may be stored in cache.

A company's specific rules may be stored in domain specific microservices. For example, if a client wants to give five additional holidays, this may be stored in client specific data in the benefits microservice. When a client/employee logs in, they may be presented with UIs that specialize based on the runtime configuration in cache plus the client specific rules stored in the microservices.

Runtime configuration changes do not necessarily need engineering involvement. In some cases, no code release may be required. Operators can change the config. With proper oversight, testing, and process, release updated configurations can be made to production without engineers being involved (e.g., with a robust Continuous Integration and Continuous Delivery (CI/CD) testing cycle). Configurations can be rolled back with support from DevOps. Also, for audit trails and approvals, every change may need to be approved before the change makes it to production (e.g., based on a specific approval chain) and may vary by service/config. Each change can have a complete log regarding why a change is being made.

Thus, in some embodiments, it may be possible to reduce the efforts of software engineers from the path of country specific configurations. If done correctly, this may be done instead by operations experts, product experts, domain experts, etc. and may not require software engineers to oversee operations. In some cases, there may be no releases for a change in config. The cache may get rebuilt automatically (e.g., with rules defined) when the config is updated. The Git check-in may trigger the CI/CD rules resulting in a new cache construction. Regarding audits and traceability, the user may know who has changed what and when. Also, the systems and methods may provide simplicity, such as in the case where it may be possible use off-the-shelf tooling (e.g., Git, Jackson, standard caching, JSON, etc.).

The variability engine 56 may deliver an infrastructure as defined herein. It is not necessary that the variability engine 56 knows anything about the business domain itself or how the configurations may be defined. The Business domain (e.g., benefits) may be a user of the infrastructure. The admin may know the configuration modeled in the YAML file, read the configuration data from the cache, and then apply it to the business domain. The admin may be unaware of the YAML file, the UI modules, or the Git versioning. FIG. 5 shows the workflow and the demarcation of responsibilities.

The YAML file may be meant for generic (non-client specific) data. The YAML file may be meant to be used only by the operator (e.g., a product manager, an in-country specialist, etc.). They may not know about the client specific configurations, and they should not be able to view or edit the client specific information, which may be a security issue.

Expressions can be added in YAML. YAML is a declarative language, meaning that it describes the desired state of a system or configuration, rather than providing a series of instructions for how to achieve that state (which would be an imperative approach, which may belong in a microservice). One YAML file may be stored for each capability. That is, Benefits may have a YAML file, the country config may have another, and so on. They may each be evaluated and added to separate parts of the cache. This allows independent changes and development.

FIGS. 6-32 are screenshots of UIs associated with execution of the employment managing program 34 of FIG. 3, according to various embodiments. For example, FIG. 6 shows a home page dashboard 90 (or home screen). The user (e.g., admin, operator, exec, HR staff, etc.) may have a first option 92 to enter data to “Set up company” and/or a second option 94 to enter data to “Start building your dream team.” The home page dashboard 90 also includes a first side link 96 to access a hiring guide and a second side link 98 to schedule consultation, which are described in more detail below. A user may wish to start with entering their companies profile information, or, in some cases, the user may wish to skip this step and go straight to a hiring process and then come back and enter the company information later.

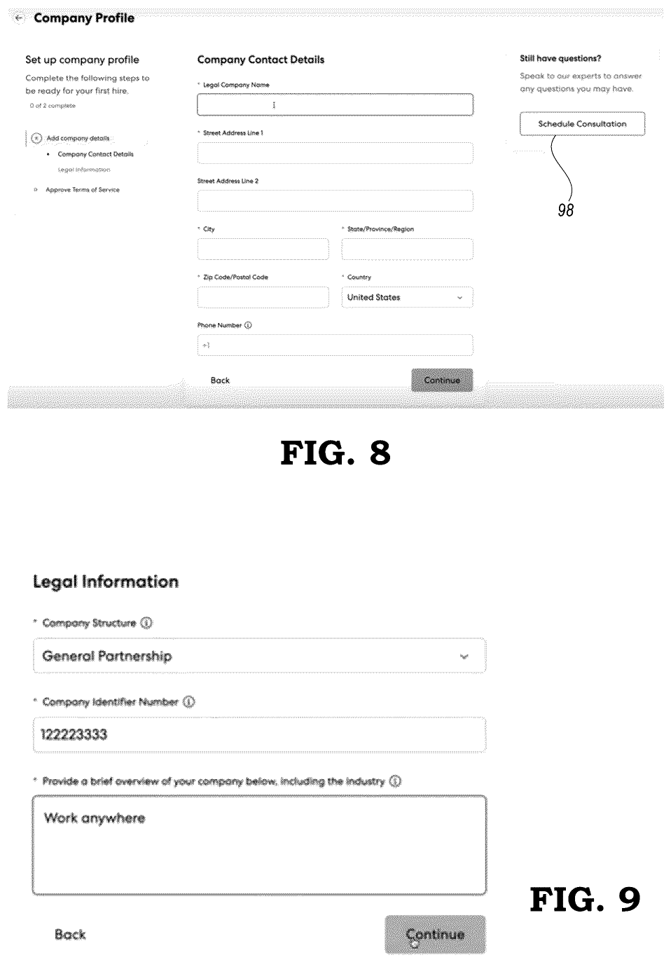

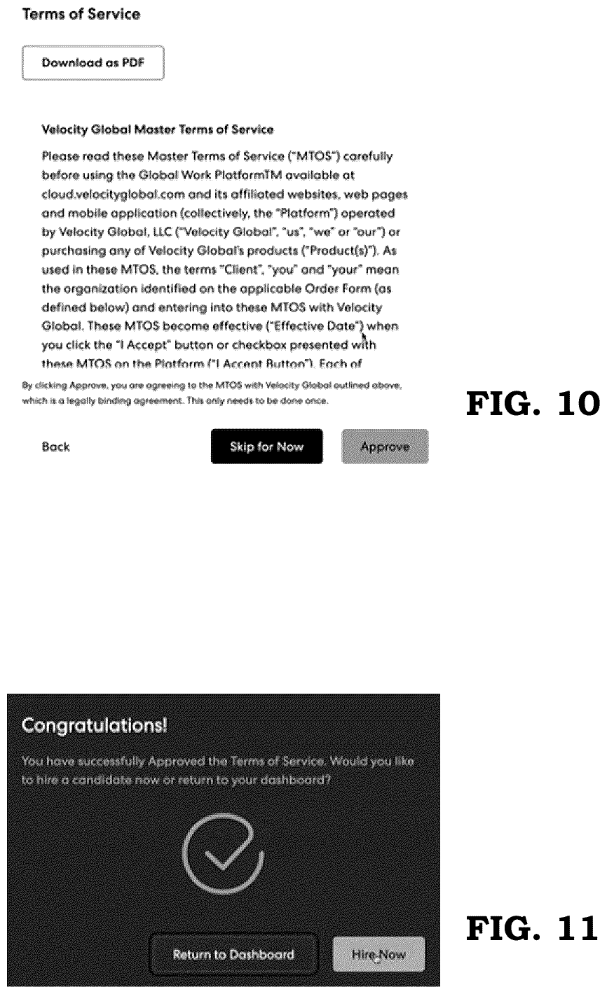

FIG. 7 shows a screenshot of a page when the user chooses to Set up information for their company. FIG. 8 shows a Company Profile page that allows entry of a company's legal name, its address, and its phone number. Also, shown in FIG. 8 is the side link 98 option to “Schedule Consultation” if the user has questions for an expert in the entry of this data. When the user hits “Continue” on the screen shown in FIG. 8, the employment managing program 34 shows the screen shown in FIG. 9, which allows the user to enter legal information. Upon continuing, the screen of FIG. 10 shows a Terms of Service screen, which may include an agreement between the specific company using the product and an organizing agency (e.g., Velocity Global, the Applicant of the present disclosure) that can act as an intermediary between a company's HR department and its employees. In this way, the services provided by the organizing agency may be configured to charge the company for the HR assistance and services offered according to the embodiments disclosed herein. When the user hits “Approve,” the screen shown in FIG. 11 is displayed showing that approval of the terms of service has been accepted. At this point, the user can return to the dashboard (i.e., home page dashboard 90 of FIG. 6) or may click on the “Hire Now” button, which is the same as selecting “Hire Now” in the second option 94 of the home page dashboard 90 of FIG. 6.

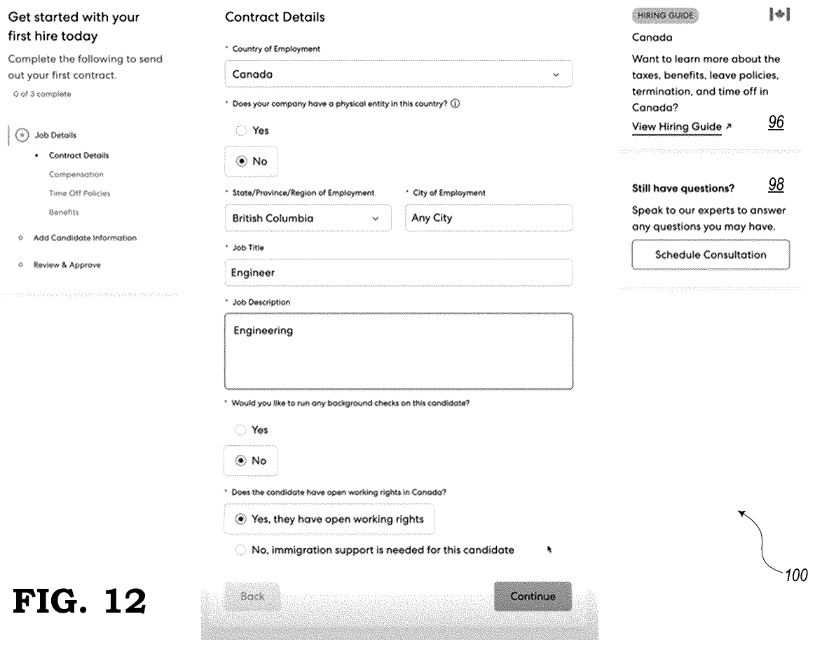

Returning back to the home screen dashboard 90 of FIG. 6 (e.g., after entering the company information), the user may select the second option 94 to start a hiring process. Again, this may be the same as clicking on the “Hire Now” button on the UI in FIG. 11. When this selection is made, the employment managing program 34 displays the Contract Details screen 100 shown in FIG. 12, which shows multiple options.

The Contract Details screen 100 includes fields for entering details about the candidate or new employee. The Contract Details screen 100 allows the user to enter a country from which an employee is to be drawn (and/or the country in which the employee will be working) along with other information regarding a state/province/region of employment, city, job title, job description, among other things. Under Country of Employment, the user may also select “Other” allowing the user to enter other information other than a specific country, as described in more detail below.

Also, the Contract Details screen 100 includes the first side link 96 and second side link 98 for allowing the user to find out more about hiring, particularly based on a country of employment entered at the top of the page. In the illustrated example, where Canada is the selected country of employment, a hiring guide may be selected that specifically defines the employment laws, rules, regulations, etc. in Canada. In particular, the hiring details may include the compensation and benefits rules of Canada, which may be monitored and recorded by the variability engine 56 shown in FIG. 3.

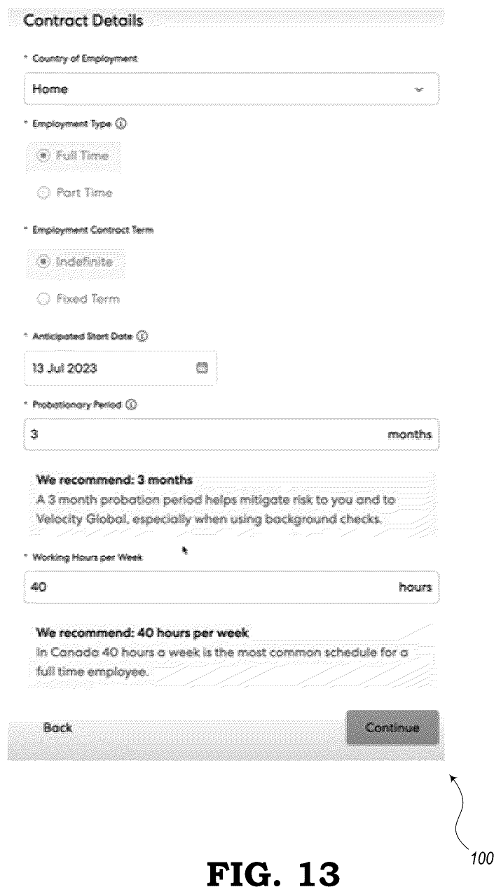

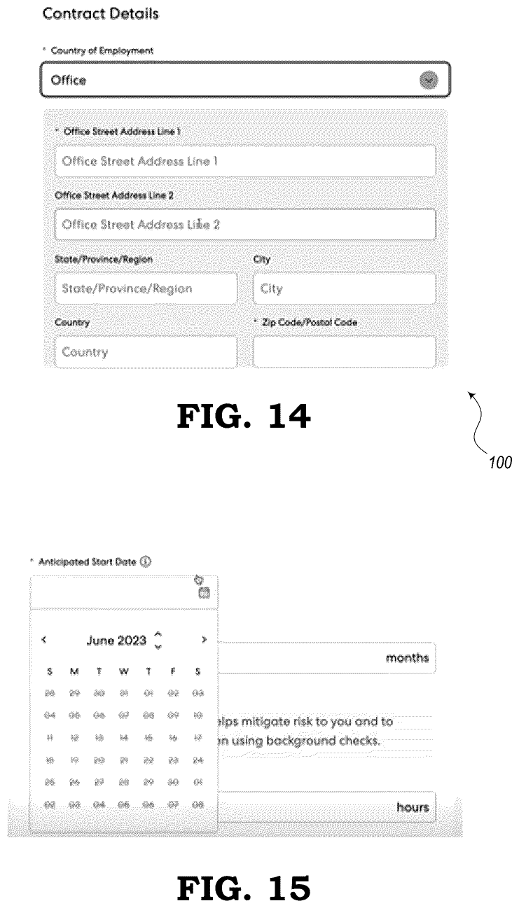

For example, when the user enters “Home” in the Country of Employment field, the employment managing program 34 may be configured to display the UI of FIG. 13. The Country of Employment field also allows the user to select other options, such as Office, Home, Hybrid, etc. When an employee intends to work from home, the home address information (e.g., or other remote address or co-working address information) for the employee can be entered. Thus, the Country of Employment section (e.g., which, in this case, may represent a physical location of the employee) allows the user to enter home, remote, in-office, or other choices for defining a location (e.g., “base” location) where the employee will physically be located to perform his, her, their, or its work-related duties. Other information regarding the employment definition can be entered. For example, if the user selects “Office” in the Country of Employment section, as shown in FIG. 14, information about that particular office can be entered, such as the business address of the company or subsidiary.

Also, after entering address information for the physical location of the employee as shown in FIGS. 13 and 14 the “Anticipated Start Date” field (e.g., which is part of the Contract Details screen 100 of FIG. 12 but shown in particular in FIG. 13) allows the user to access a pop-up, shown in FIG. 15, illustrating a calendar of future dates from which to select. Typically, according to normal policies and/or according to various employment laws or regulations, the user may enter an anticipated start date that is at least about 14 days out from the date that a job offer is approved.

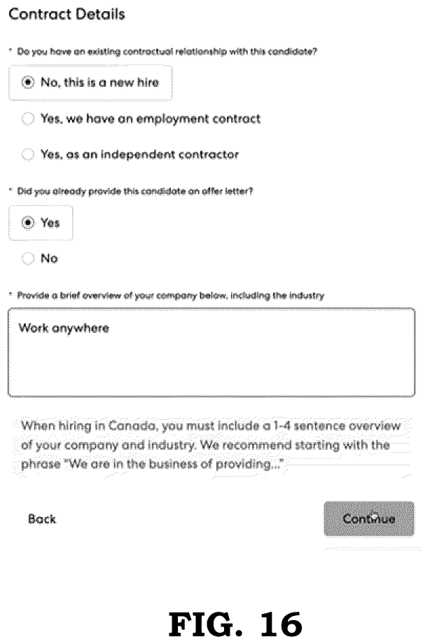

The user may enter other types of information in the Contract Details screen 100 of FIGS. 12-14. For example, the user may enter information regarding a probation period and expected number of work hours per week. The user may simply select recommended options of three months and 40 hours per week. When “Continue” is selected in the Contract Details screen 100, a continuation of the screen is shown in FIG. 16, allowing the user to enter more contract details. The screen may automatically provide additional instructions that may be relevant to the particular country, state, province, etc. where the company may be hiring from.

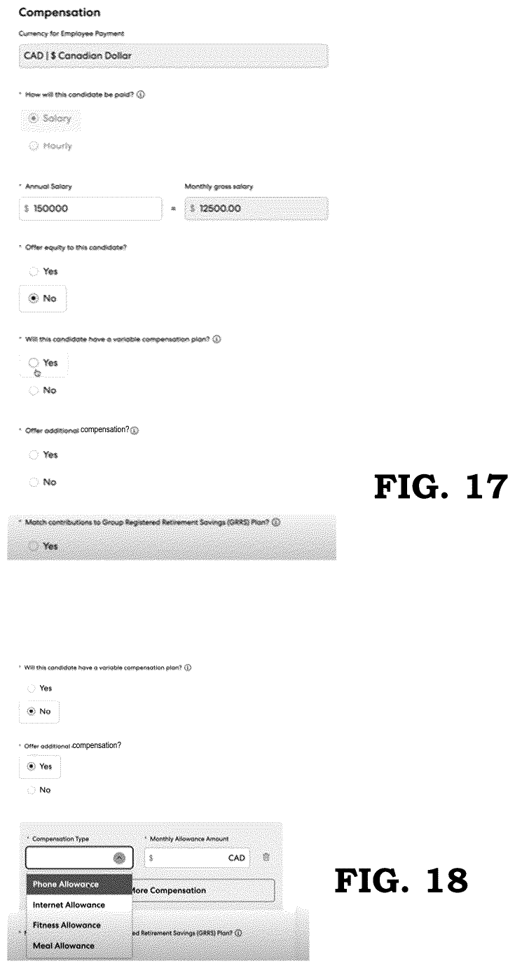

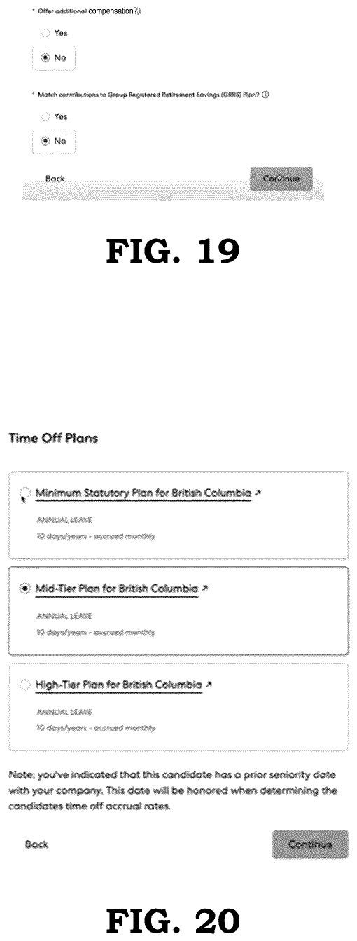

The user may continue entering more job description information in the Contract Details screen 100. In FIG. 17, a screen is shown where the user can enter compensation information, such as salary. The UI includes options to select whether the user wishes to offer equity or variable compensation. If additional compensation is to be offered, the pop-up shown in FIG. 18 is displayed. This screen allows the user to select various “allowances” (e.g., phone allowance, Internet usage allowance, fitness allowance, meal allowance, travel/transportation allowance, parking allowance, etc.). FIG. 19 is a continuation of the screen shown in FIG. 17 to allow entry of additional information.

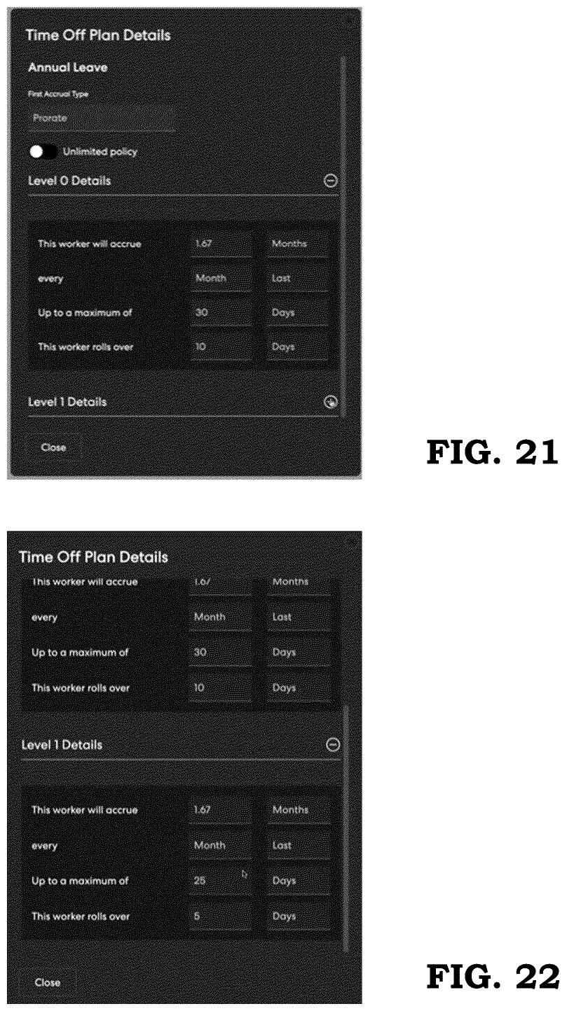

Next, the user may enter time off plans, as shown in FIG. 20. Different plans may be presented for the user's selection and may be based on the local employment laws, rules, regulations, etc. for the particular country in which the employee is planning to work. The screen may show a minimum option that meets a minimum requirement according to the various laws as well as a mid-tier plan, a high-tier plan, and/or other plans. FIGS. 21 and 22 show screenshots of a screen depicting the details of a selected time-off plan. By clicking on the various options shown in FIG. 20, the UIs are configured to display different sets of information that may be useful for informing the user of the various time-off options. This can give the user an opportunity to compare levels and different plans.

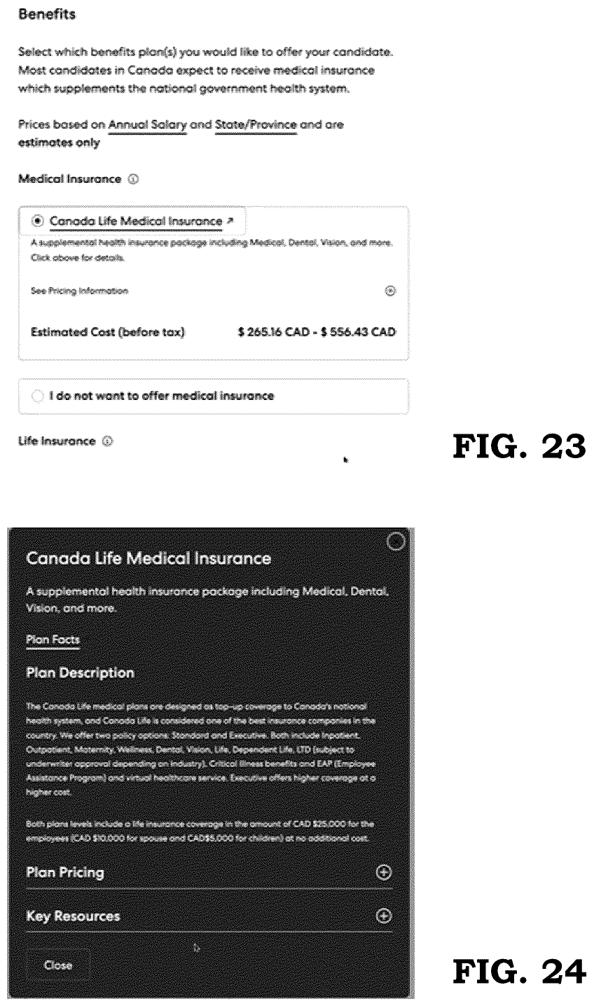

When continuing with the entry of job description information, the user then has the opportunity to enter information regarding medical/health insurance, as shown in FIG. 23. Based on the country of employment and various options provided by the company, the user can view plan pricing for medical/health insurance, life insurance disability insurance, workers compensation, and/or other types of insurance. FIGS. 24-28 show various windows or pop-ups that are shown during the insurance entry phase. The user can view plan pricing and the UI can present a breakdown of the differences based on various coverage levels. Other options (e.g., life insurance payout amounts) may be selected (e.g., two times the employee's salary, etc.).

Next, the user (admin) may enter candidate (or new employee) information as shown in the example of FIG. 29. In some embodiments, this UI or screen can also be presented to the candidate or new employee himself or herself to allow the person to enter certain information. For example, information for the candidate or new employee may include name, email address, phone number, etc.

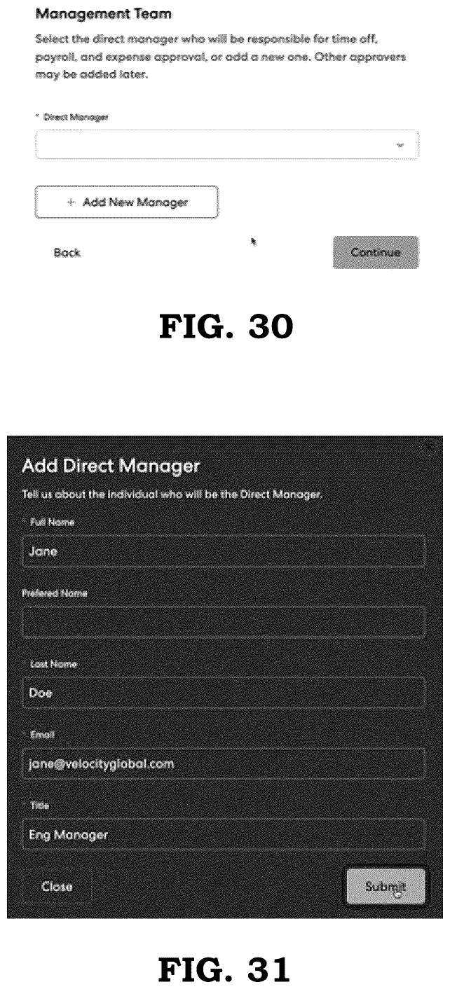

The next screen, shown in FIG. 30, allows the user (e.g., admin, candidate, new employee) to enter information about the new employee's manager and/or team. For the direct manager, this is where the user can select from a list of managers that have already been entered for the company. The screen of FIG. 30 allows the entry (by the admin) to enter a new manager, for instance, particularly if this is a first time that the manager's information is entered or if this is an initial entry or onboarding of manager information into the system. When the “Add New Manager” button is selected in FIG. 30, the screen of FIG. 31 is displayed, which allows entry of the manager's information, such as name, phone number, email address, etc. In some embodiments, the employment managing program 34 of FIG. 3 may be configured to detect if the entered domain (e.g., “@velocityglobal.com”) of the new manager's email address matches one or more domains associated with the company receiving HR-related services described herein. If the domain does not match during a validation check, the employment managing program 34 may be configured to provide an error message to the user.

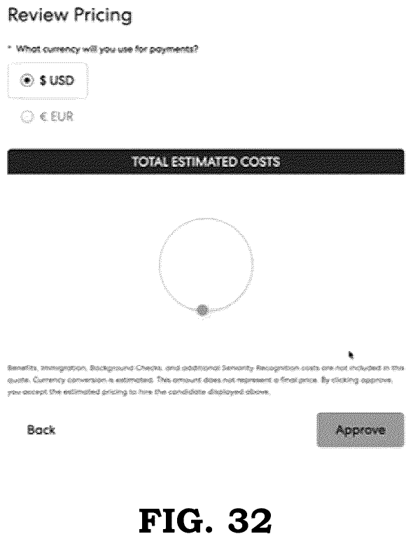

When the user has completed the entry of the company information using the first option 92 of the home page dashboard 90 of FIG. 6 and has completed the entry of information for each of one or more candidate using the second option 94, the user may then select a “Calculate” button (not shown) or other similar option. At this point, the employment managing program 34 is configured to proceed to a final step in the process, which is shown in FIG. 32. The employment managing program 34 is configured to calculate a pricing that represents a quote for the management company (e.g., Velocity Global) to represent the particular company with respect to HR-type services. The estimate or quote may be provided based on the value of managing employees in one or more countries, managing any recruitment services needed, providing guidance regarding employment laws and rules in different jurisdictions (e.g., compensation, benefits, etc.), providing onboarding services, managing payroll and timekeeping services, managing termination and retirement services, etc. This page may also be configured to show a breakdown of the cost analysis. If the representative (e.g., admin, HR staff, executive, etc.) for the company agrees with the quote, the representative may click on the “Approve” button.

According to various embodiments of the present disclosure, the employment managing program 34 may be configured to display the various screens on the user's UI to allow the user to view and enter information regarding the company and one or more candidates. The various compensation and benefits screens described in the present disclosure are typically not presented in a such an efficient manner in conventional systems. This can therefore greatly simplify the entry of information and help manage the employment considerations for an HR department. For example, the ability of the employment managing program 34 to show information regarding medical benefits, as shown in FIGS. 23-28, is absent from conventional systems. Also, the seamless processing of compensation and time-off information, as shown in FIGS. 17-22 are also absent from conventional systems. Thus, the embodiments of the employment managing program 34 may be configured to provide novel HR managing services for a company. Also, the quick calculation of a quote for providing these services to a company is also believed to be an advantage over conventional systems, which normally do not offer such pricing options. Again, the various information related to compensation, benefits (e.g., medical, life, PTO, etc.), and service price quotes can be based on information retrieved and recorded by the variability engine 56 that is configured to maintain updated data regarding various employment laws, rules, regulations, etc. in each of a plurality of countries.

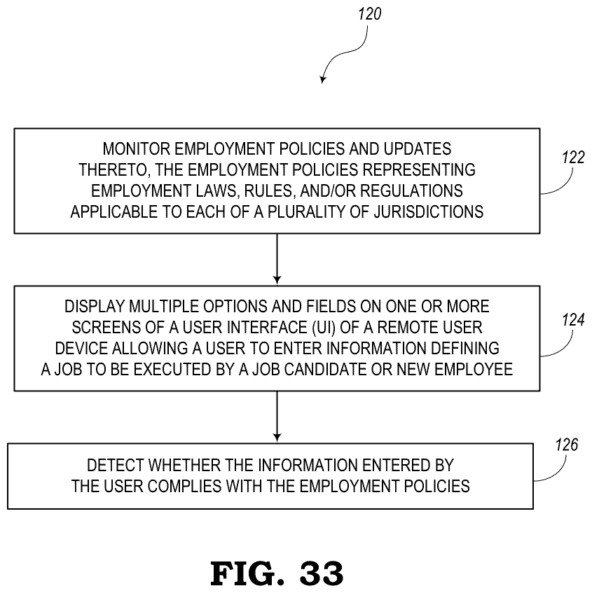

FIG. 33 is a flow diagram illustrating an embodiment of a method 120 for managing employment functionality for a business. As illustrated, the method 120 includes the step of monitoring employment policies and updates thereto, as indicated in block 122, wherein the employment policies represent employment laws, rules, and/or regulations applicable to each of a plurality of jurisdictions. The method 120 further includes the step of displaying multiple options and fields on one or more screens of a User Interface (UI) of a remote user device allowing a user to enter information defining a job to be executed by a job candidate or new employee, as indicated in block 124. Also, the method 120 includes the step of detecting whether the information entered by the user complies with the employment policies, as indicated in block 126.

The method 120 may also be executed according to various implementations. For example, the remote user device (block 124) may be associated with a company for which the job is intended to be filled. The user may be administrative, executive, or Human Resources (HR) personnel representing the company. The method 120 may be executed by a cloud-based server configured to provide automated HR services for the one or more companies or employers. The method 120 may further includes the step of displaying a quote on the UI, where the quote may be a cost for the cloud-based server to serve the company with respect to the HR services.

The step of displaying the multiple options and fields (block 124) may include the steps of a) displaying compensation options and fields and b) displaying benefits options and fields. The step of detecting whether the information entered by the user complies with the employment policies (block 126) may include a first step of detecting whether compensation information entered by the user complies with the employment policies with respect to a selected jurisdiction, where the compensation information is related to a) an annual salary, b) an hourly wage, c) equity, d) variable compensation, e) bonuses, f) allowances, g) retirement matching, and/or other elements related to compensation. The step of detecting whether the information entered by the user complies with the employment policies (block 126) may further include a second step of detecting whether benefits information entered by the user complies with the employment policies with respect to the selected jurisdiction, the benefits information related to a) Paid Time Off (PTO), b) medical/health insurance, c) life insurance, and/or other benefits.

The plurality of jurisdictions, for example, may include a plurality of countries throughout the world. Each of one or more of the plurality of countries may include one or more states, provinces, territories, cantons, divisions, regions, landers, governorates, parishes, or prefectures each having their own set of employment policies.

The method 120 may further include automatically managing one or more of a) a first set of tasks related to recruiting and onboarding new employees, b) a second set of tasks related to payroll and timekeeping, c) a third set of tasks related to employee relocation, and d) a fourth set of tasks related to termination or retirement of employees. The method 120 may also include the step of updating the first, second, third, and fourth sets of tasks based on updates to the employment policies.

In some embodiments, the method 120 may also include the step of displaying hiring guidelines on the UI, where the hiring guidelines may be related to the employment policies of one or more of the plurality of jurisdictions. The method 120 may also consider factors regarding locations of one or more job candidates with respect to one or more of a) hiring locally, b) hiring internationally, c) remote work, d) establishing a subsidiary in another jurisdiction, e) passport policies, f) immigration policies, and g) work visa policies.

According to some embodiments, the method 120 may further include a company flowchart that can include the following:
1. The company may wish to hire Candidate X in Country Y. They can enter the job description data as well as the new candidate information on the cloud platform of the server 16, the information including pay, duties, etc.
2. The company can provide Candidate X with an offer letter from the cloud platform with full compliance with laws in Country Y.
3. Then, Candidate X can go to the cloud platform and either accept or reject the offer. If accepted, Candidate X can enter his or her personal data (e.g., bank account information, residence address, etc.).
4. When Candidate X begins working for the company and becomes Employee X, Employee X may update his or her personal data as needed. The cloud platform may be configured to provide other HR services, such as making payments to Employee X and ensuring that all local laws are complied with based on the encoded rules for Country Y.

According to one example, suppose that dock workers in France have become unionized. The employment managing program 34 may be configured to enter such a rule that asks for a union number of the new employee and verify that the union number is placed in a database (e.g., database 30). This and other types of similar situations can be monitored by the variability engine 56 of the employment managing program 34 and entered into the database. The relevant information can be provided as options or fields that can be added to the various screens provided to the UI of the remote user device and/or can allow the user to select certain options to ensure that updated employment policies are adhered to.

In some cases, there may be a hierarchy of rules. For example, suppose that PTO in the UK has a minimum requirement of 20 days off. However, suppose that a local law in London requires 25 days. Suppose too that a company wishes to offer more than the minimum and includes an option for the user to select 30 days and to provide 35 days for engineers working in London. Therefore, the job title information, work location information, and specific company information can all be used to determine a minimum amount of time off for engineers working in London.

In some embodiments, when the user clicks on the option 96 to learn more about certain hiring guidelines, the employment managing program 34 may be configured to display information to instruct a hiring manager of other company representative about the relevant employment policies in a specific country (or other jurisdiction) of employment. Again, the employment policies may include the specific employment laws, rules, regulations (e.g., taxes, leave policies, termination rules, time off policies, retirement policies, etc.) in the area where the company is intending to hire from or where a current employee is intended to be transferred or relocated to. This information may help the user to enter information and conform to the applicable policies.

Furthermore, the employment managing program 34 is further configured to determine a cost associated with hiring an employee from a particular location and providing compensation and benefits to the employee. Therefore, this can be done in a trial mode without actually advertising the job opening, interviewing candidates, or providing an offer letter. Therefore, the company can see the cost of hiring such a candidate and compare the cost with hiring from one or more other locations based on other applicable employment policies. This can be used by the company to determine various costs for establishing a business presence in different countries, states, regions, territories, provinces, etc. Also, this information can be used for encouraging the hiring of employees from certain remote countries, allowing employees to work remotely in these places, etc.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A non-transitory computer-readable medium configured to store computer logic having instructions enabling a processor to perform the steps of:
monitoring employment policies and updates thereto, the employment policies representing employment laws, rules, and/or regulations applicable to each of a plurality of jurisdictions, wherein the employment policies are captured in a data format and the updates are maintained via a version control feature;
displaying multiple options and fields on one or more screens of a User Interface (UI) of a remote user device allowing a user to enter information defining a job to be executed by a job candidate or new employee; and
detecting whether the information entered by the user complies with the employment policies.

2. The non-transitory computer-readable medium of claim 1, wherein the remote user device is associated with a company for which the job is intended to be filled, and wherein the user includes one or more administrative, executive, or Human Resources (HR) personnel representing the company.

3. The non-transitory computer-readable medium of claim 2, wherein the non-transitory computer-readable medium is part of a cloud-based server configured to provide automated HR services for the company and one or more additional companies.

4. The non-transitory computer-readable medium of claim 3, wherein the instructions further enable the processor to display a quote on the UI, the quote being a cost for the cloud-based server to serve the company with respect to the automated HR services.

5. The non-transitory computer-readable medium of claim 1, wherein the step of displaying the multiple options and fields includes the steps of:
displaying compensation options and fields; and
displaying benefits options and fields.

6. The non-transitory computer-readable medium of claim 5, wherein the step of detecting whether the information entered by the user complies with the employment policies includes the steps of:
detecting whether compensation information entered by the user complies with the employment policies with respect to a selected jurisdiction, the compensation information related to one or more of an annual salary, an hourly wage, equity, variable compensation, bonuses, allowances, and retirement matching; and
detecting whether benefits information entered by the user complies with the employment policies with respect to the selected jurisdiction, the benefits information related to one or more of Paid Time Off (PTO), medical/health insurance, and life insurance.

7. The non-transitory computer-readable medium of claim 1, wherein the plurality of jurisdictions includes a plurality of countries throughout the world.

8. The non-transitory computer-readable medium of claim 7, wherein each of one or more of the plurality of countries includes one or more states, provinces, territories, cantons, divisions, regions, landers, governorates, parishes, or prefectures each having their own set of employment policies.

9. The non-transitory computer-readable medium of claim 1, wherein the instructions further enable the processor to perform the step of automatically managing one or more of a) a first set of tasks related to recruiting and onboarding new employees, b) a second set of tasks related to payroll and timekeeping, c) a third set of tasks related to employee relocation, and d) a fourth set of tasks related to termination or retirement of employees.

10. The non-transitory computer-readable medium of claim 9, wherein the instructions further enable the processor to update the first, second, third, and fourth sets of tasks based on updates to the employment policies.

11. The non-transitory computer-readable medium of claim 1, wherein the instructions further enable the processor to display hiring guidelines on the UI, the hiring guidelines related to the employment policies of one or more of the plurality of jurisdictions.

12. The non-transitory computer-readable medium of claim 1, wherein the instructions further enable the processor to consider factors regarding locations of one or more job candidates with respect to one or more of a) hiring locally, b) hiring internationally, c) remote work, d) establishing a subsidiary in another jurisdiction, e) passport policies, f) immigration policies, and g) work visa policies.

13. The non-transitory computer-readable medium of claim 1, wherein the data format is one of YAML, JavaScript Object Notation (JSON), and S3 buckets, and the version control feature includes Git.

14. A cloud-based server comprising:
a processing device; and
a memory device configured to store a computer program having instructions that, when executed, enable the processing device to
monitor employment policies and updates thereto, the employment policies representing employment laws, rules, and/or regulations applicable to each of a plurality of jurisdictions, wherein the employment policies are captured in a data format and the updates are maintained via a version control feature,
display multiple options and fields on one or more screens of a User Interface (UI) of a remote user device allowing a user to enter information defining a job to be executed by a job candidate or new employee, and
detect whether the information entered by the user complies with the employment policies.

15. The cloud-based server of claim 14, wherein the remote user device is associated with a company for which the job is intended to be filled, wherein the user includes one or more administrative, executive, or Human Resources (HR) personnel representing the company, and wherein the cloud-based server is configured to provide automated HR services for the company and one or more additional companies.

16. The cloud-based server of claim 15, wherein the instructions further enable the processing device to display a quote on the UI, the quote being a cost to serve the company with respect to the HR services.

17. The cloud-based server of claim 14, wherein the step of displaying the multiple options and fields includes the steps of:
displaying compensation options and fields; and
displaying benefits options and fields;
and wherein the step of detecting whether the information entered by the user complies with the employment policies includes the steps of:
detecting whether compensation information entered by the user complies with the employment policies with respect to a selected jurisdiction, the compensation information related to one or more of an annual salary, an hourly wage, equity, variable compensation, bonuses, allowances, and retirement matching; and
detecting whether benefits information entered by the user complies with the employment policies with respect to the selected jurisdiction, the benefits information related to one or more of Paid Time Off (PTO), medical/health insurance, and life insurance.

18. A method comprising the steps of:
monitoring employment policies and updates thereto, the employment policies representing employment laws, rules, and/or regulations applicable to each of a plurality of jurisdictions, wherein the employment policies are captured in a data format and the updates are maintained via a version control feature;
displaying multiple options and fields on one or more screens of a User Interface (UI) of a remote user device allowing a user to enter information defining a job to be executed by a job candidate or new employee; and
detecting whether the information entered by the user complies with the employment policies.

19. The method of claim 18, wherein the plurality of jurisdictions includes a plurality of countries throughout the world, and wherein each of one or more of the plurality of countries includes one or more states, provinces, territories, cantons, divisions, regions, landers, governorates, parishes, or prefectures each having their own set of employment policies.

20. The method of claim 18, further comprising the steps of:
automatically managing one or more of a) a first set of tasks related to recruiting and onboarding new employees, b) a second set of tasks related to payroll and timekeeping, c) a third set of tasks related to employee relocation, and d) a fourth set of tasks related to termination or retirement of employees; and
updating the first, second, third, and fourth sets of tasks based on updates to the employment policies.
